(19) United States
(12) Patent Application Publication
(10) Pub. No.: US 2003/0169592 A1
(43) Pub. Date: Sep. 11, 2003

(54) Mini-bulb assembly

(76) Inventor: Chun-Ming Liu, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/092,597

(22) Filed: Mar. 8, 2002

(51) Int. Cl. F21V 21/00

(52) U.S. Cl. 362/249

(57) ABSTRACT

The present invention relates to a mini-bulb assembly, which includes a mini-bulb with two tiny conductive wires, a receiver having a downward separating rod with two arched channels, and a holder with a taper inner hole. The mini-bulb can be received in the receiver, both of which are then received in the holder that proffers a clamping force to clip the mini-bulb and the electrical wires in the holder for obtaining a secure mini-bulb assembly with a simplified structure.

### BACKGROUND OF THE INVENTION

A mini-bulb assembly includes a very small bulb, which has a pair of tiny conductive wire. During being connected with electrical wires, the tiny conductive wire of the mini-bulb must be welded for electrical connection. It is known that the prior mini-bulb assembly can not be engaged in secure since the mini-bulb is so small, which is possibly loose. If a conductive plate is used in the mini-bulb assembly, it will have a large scare and is not utilized.

Accordingly, the primary object of the invention is to provide a novel mini-bulb assembly, which is provided with a receiver for engaging the mini-bulb firmly. Now the features and advantages of the present invention will be described in detail with reference to the accompanying drawings.

### BRIEF DESCRIPTION OF ACCOMPANYING DRAWINGS

FIG. 1 is a perspective view showing a receiver and a holder according to the present invention.

FIG. 2 is an exploded perspective view showing a mini-bulb assembly connecting with electrical wires according to the present invention.

FIG. 3 is an assembled perspective view of FIG. 2 according to the present invention.

FIG. 4 is a cross-sectional plan view of FIG. 2 according to the present invention.

FIG. 5 is a cross-sectional plan view of FIG. 3 according to the present invention.

### DETAILED DESCRIPTION OF PREFERRED EMBODIMENTS

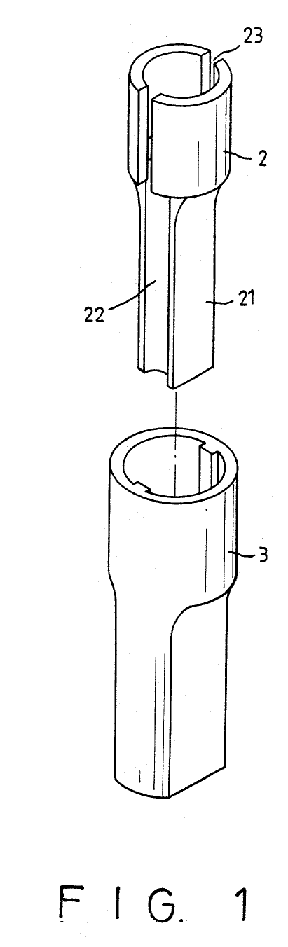

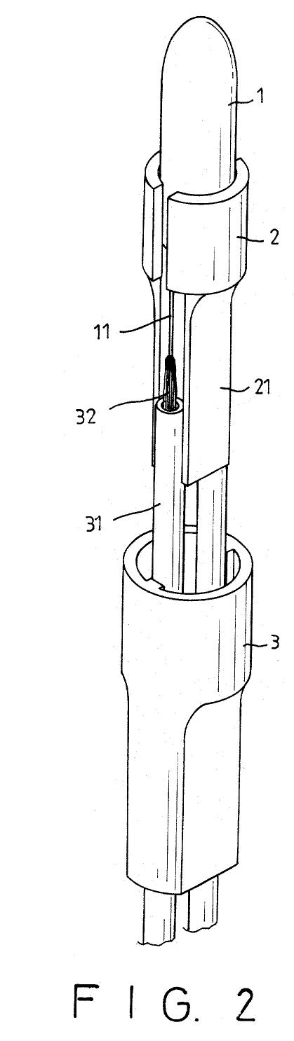

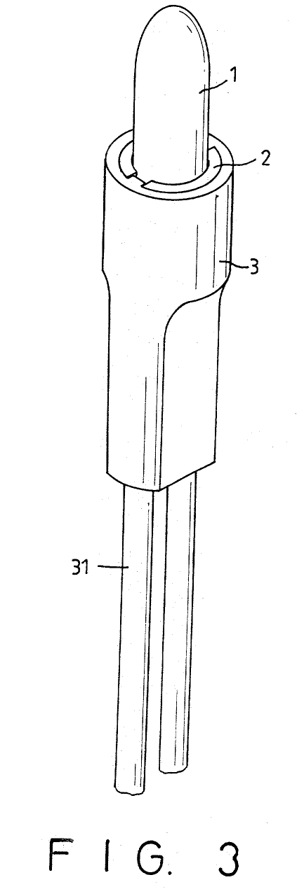

Please firstly refer to FIGS. 1 to 3, the present invention mainly includes a mini-bulb (1), a receiver (2), and a holder (3). The receiver (2) has a downward separating rod (21) with two arched channel (22) at both sides. The receiver (2) is also provided with two opposite gaps (23) at main body. The mini-bulb (1) is received in the receiver (2) and has two tiny conductive wires (11), each of which is extended alone the channel (22). The electrical wires (31) passing through the holder (3) have top metal wires (32), which can be welded with the conductive wire (11) of the mini-bulb (1) for electrical connection. The receiver (2) together with the mini-bulb (1) is then received in the holder (3) to obtain an assembled engagement of a mini-bulb assembly.

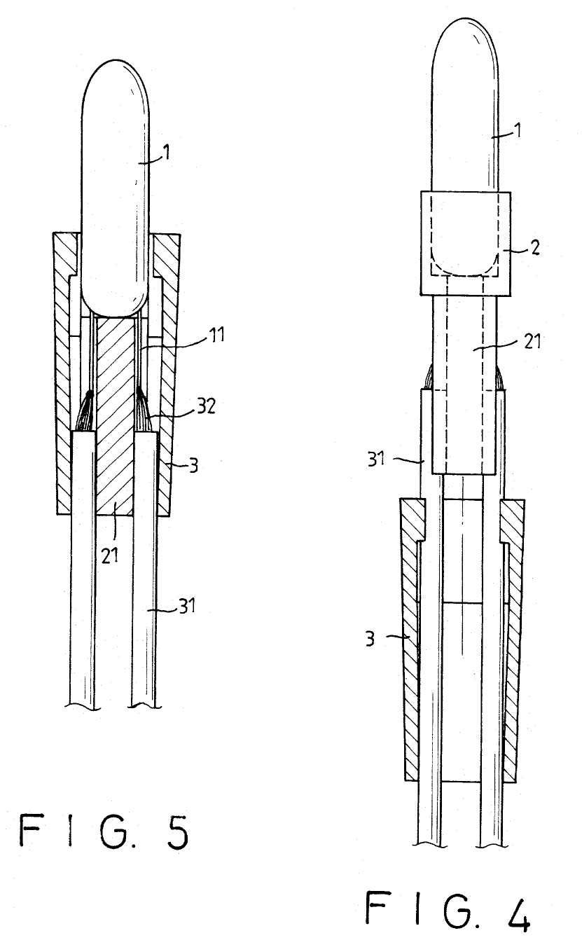

Referring to FIGS. 4 and 5, the holder (3) is provided with a taper inner hole. When the receiver (2) is put into the holder (3), there proffers a force to squeeze the electrical wires firmly. Moreover, the holder (3) can clamp the receiver (2) to clip the mini-bulb in secure since there are gaps (23) provided on the receiver (2). It is to be understood that the mini-bulb assembly according to the present invention is simplified without a conductive plate provided in a prior structure.

Accordingly, the invented assembly of the present invention obviously obtains utility and improvement. It should be allowed for patent and is applied.

What is claimed is:

1. A mini-bulb assembly including a mini-bulb, a receiver, and a holder, wherein the receiver has a separating rod with two side arched channels and has two opposite gaps at main body, the mini-bulb having two tiny conductive wires is received in the receiver while the conductive is extended alone the arched channel to be connected with metal wires of electrical wires passed through the holder, and the holder has a taper inner hole for clamping the electrical wires and the receiver to clip the mini-bulb firmly.
